(19) United States
(12) Patent Application Publication
(10) Pub. No.: US 2026/0326829 A1
(43) Pub. Date: Oct. 22, 2026

(54) FLOOR STRUCTURE FOR ELECTRIC VEHICLE

(71) Applicants: Hyundai Motor Company, Seoul (KR); Kia Corporation, Seoul (KR)

(72) Inventors: Hyeongseok Lee, Hwaseong-si (KR); Kwang Hee An, Hwaseong-si (KR)

(21) Appl. No.: 19/390,131

(22) Filed: Nov. 14, 2025

(30) Foreign Application Priority Data
Apr. 17, 2025 (KR) 10-2025-0050114

(51) Int. Cl. B62D 25/20; B60K 1/04; B60L 15/00; B60L 50/60; B62D 25/02

(52) U.S. Cl. CPC B62D 25/2036; B60K 1/04; B60L 15/007; B60L 50/66; B62D 25/025; B60K 2001/0438

(57) ABSTRACT

A floor structure for an electric vehicle includes a center floor panel connected to side sills and a tunnel member disposed along the forward-backward direction of a vehicle body, seat cross members connected along the vehicle width direction to the upper portion of the center floor panel and connected to both sides of the tunnel member and the side sills, at least one brace reinforcement member connected to the inside of the tunnel member in a position corresponding to the seat cross members, and an inverter assembly connected with the at least one brace reinforcement member.

### CROSS-REFERENCE TO RELATED APPLICATIONS

This application claims priority to and the benefit of Korean Patent Application No. 10-2025-0050114 filed with the Korean Intellectual Property Office on Apr. 17, 2025, the entire contents of which are incorporated herein by reference.

### TECHNICAL FIELD

The disclosed embodiment relates to a vehicle body structure of an electric vehicle, and more particularly, the present disclosure relates to a center floor structure adapted to mount a seat and a battery assembly.

### BACKGROUND

Due to recent strengthened environmental and fuel efficiency regulations, the use of electric vehicles powered by electric propulsion systems is increasing.

An electric vehicle is equipped with a battery assembly that supplies electricity to the electric drive source. For example, the battery assembly is mounted on the lower part of the center floor structure of the vehicle body of an electric vehicle.

However, the center floor structure is disadvantageous in terms of strength due to the increase in electric drive components, the increase in wheel base, and the mounts for seats and battery assemblies, and can cause excessive vibration.

In the case of a side collision, the center floor structure may cause damage to the battery assembly and occupants due to rotational deformation of the side sill as the collision load is concentrated on the side of the side sill.

The information contained in this background section is intended to enhance understanding of the background of the invention and may include matters that are not conventional art already known to a person of ordinary skill in the field to which this technology belongs.

### SUMMARY

The present disclosure attempts to provide a floor structure for an electric vehicle that can secure connectivity of components, reinforce the strength of a vehicle body, and improve the lateral collision performance of the vehicle.

A floor structure for an electric vehicle according to the disclosed embodiment may include a center floor panel connected to side sills and a tunnel member disposed along the forward-backward direction of a vehicle body, seat cross members connected along the vehicle width direction to the upper portion of the center floor panel and connected to both sides of the tunnel member and the side sills, at least one brace reinforcement member connected to the inside of the tunnel member in a position corresponding to the seat cross members, and an inverter assembly connected with the at least one brace reinforcement member.

The floor structure may further include an inner seat mounting bracket connected to one end of the seat cross members and both ends of the tunnel member, and an outer seat mounting bracket connected to the other end of the seat cross members and the side sills.

The at least one brace reinforcement member may be disposed between the seat cross members within the tunnel member and connected to the inner surface of the tunnel member with a U-shape.

The at least one brace reinforcement member may be connected to the inner surface of the tunnel member through a connecting flange portion formed at the edge.

The inverter assembly may include an inverter main body, an upper cover connected to the upper portion of the inverter main body, and a lower cover connected to the lower portion of the inverter main body and connected to the at least one brace reinforcement member.

The at least one brace reinforcement member may be connected to the lower cover through fasteners provided on both lower sides.

The lower cover may include cantilever-shaped mounting ribs connected with the fasteners.

The mounting ribs may be disposed in the same line as the seat cross members along the vehicle width direction.

The seat cross members, which are disconnected along the vehicle width direction by the tunnel member, may be connected through the at least one brace reinforcement member and the mounting ribs.

The mounting ribs may form a load path that is connected to the seat cross members through the tunnel member and the at least one brace reinforcement member.

The tunnel member may include a forming portion that protrudes outward at a position corresponding to the lower sides of the at least one brace reinforcement member and is disposed on the inner side of the seat cross members.

The inverter assembly may include a lower cover connected to the lower portion of the inverter main body and connected to the lower portions of both sides of the at least one brace reinforcement member.

The lower cover may include mounting ribs extending from the inner side of the tunnel member to the form portion and connected to fasteners provided on the at least one brace reinforcement member.

The cross-sections of the seat cross members and the mounting ribs may overlap by the forming portion.

A battery assembly may be mounted on lower portion of the center floor panel.

According to the floor structure for an electric vehicle according to the disclosed embodiment, the connectivity of parts disposed along the vehicle width direction can be secured, and the connecting strength of the vehicle body can be reinforced.

According to the floor structure for an electric vehicle according to the disclosed embodiment, the side collision performance of the vehicle can be improved to minimize injury to an occupant and damage to a battery assembly.

In addition, any effects that can be obtained or expected from the disclosed embodiment are disclosed directly or implicitly in the detailed description of the disclosed embodiment of the present invention. That is, various effects expected according to the disclosed embodiment will be disclosed in the detailed description that follows.

### BRIEF DESCRIPTION OF THE DRAWINGS

These drawings are for reference in describing exemplary disclosed embodiments, and therefore, the technical idea of the present disclosure should not be construed as limited to the attached drawings.

FIG. 1 is a perspective view illustrating a floor structure for an electric vehicle according to the disclosed embodiment.

FIG. 2 is a partially exploded perspective view illustrating a floor structure for an electric vehicle according to the disclosed embodiment.

FIG. 3 is a partially exploded front view illustrating a floor structure for an electric vehicle according to the disclosed embodiment.

FIG. 4 is a cross-sectional view illustrating a floor structure for an electric vehicle according to the disclosed embodiment.

FIG. 5 is an exploded perspective view illustrating a brace reinforcement member applied to a floor structure for an electric vehicle according to the disclosed embodiment.

FIG. 6 is a cross-sectional view illustrating a brace reinforcement member applied to a floor structure for an electric vehicle according to the disclosed embodiment.

FIG. 7 is a cross-sectional view illustrating a floor structure for an electric vehicle according to another disclosed embodiment.

### DESCRIPTION OF SYMBOLS

1: battery assembly
10: side sill
20: center floor panel
30, 130: tunnel member
40, 140: seat cross member
41: inner seat mounting bracket
43: outer seat mounting bracket
50, 150: brace reinforcement member
51: connecting flange
53: channel portion
55: closed cross-section
57: fastener
70, 170: inverter assembly
71: inverter main body
73: upper cover
75: 175: lower cover
77, 177: mounting rib
78: fastening hole
79: nut
81: load path
90: forming portion
100, 200: floor structure

The drawings referenced above are not necessarily drawn to scale, but should be understood as presenting representations of various features illustrating the basic principles of the disclosed embodiment. For example, certain design features, including specific dimensions, direction, position, and shape, will be determined in part by the particular intended application and use environment.

### DETAILED DESCRIPTION OF ILLUSTRATIVE EMBODIMENTS

Hereinafter, with reference to the attached drawings, the disclosed embodiments will be described in detail so that a person having ordinary skill in the art to which the disclosed embodiments pertain can easily carry out the disclosed embodiments. However, the disclosed embodiments may be implemented in many different forms and are not limited to the embodiments described herein.

The terminology used herein is for the purpose of describing particular embodiments only and is not intended to limit the present disclosure. As used herein, the singular forms are intended to include the plural forms as well, unless the context clearly indicates otherwise.

It should also be understood that the terms “including” and/or “comprising” as used in this specification indicate the presence of stated features, integers, steps, operations, elements and/or components, but do not preclude the presence or addition of one or more other features, integers, steps, operations, components, and/or groups thereof. As used in this specification, the term ‘and/or’ includes any one or all combinations of one or more of the associated listed items.

In this specification, the term ‘connected’ indicates a physical relationship between two components where the components are directly connected to each other or indirectly connected through one or more intermediary components.

The terms “vehicle”, “car”, “vehicle of”, “vehicular” or other similar terms used in this specification include vehicles including sports utility vehicles (SUVs), buses, trucks, passenger vehicles including various commercial vehicles, ships including various types of boats and vessels, aircraft and the like, as well as hybrid vehicles, electric vehicles, plug-in hybrid electric vehicles, hydrogen fuel vehicles and other alternative fuel (e.g., fuel obtained from resources other than petroleum) vehicles.

Hereinafter, disclosed embodiments will be described in detail with reference to the attached drawings.

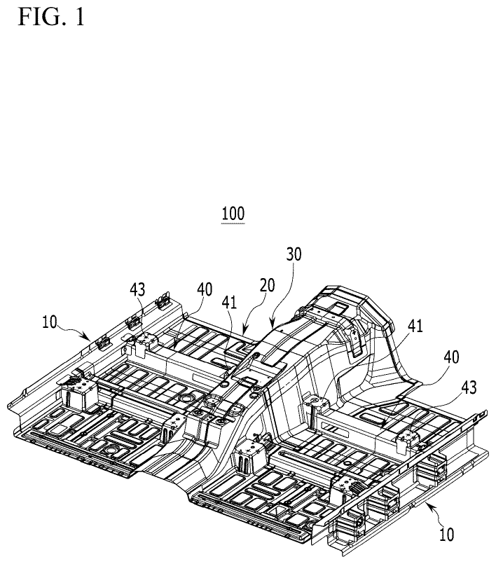

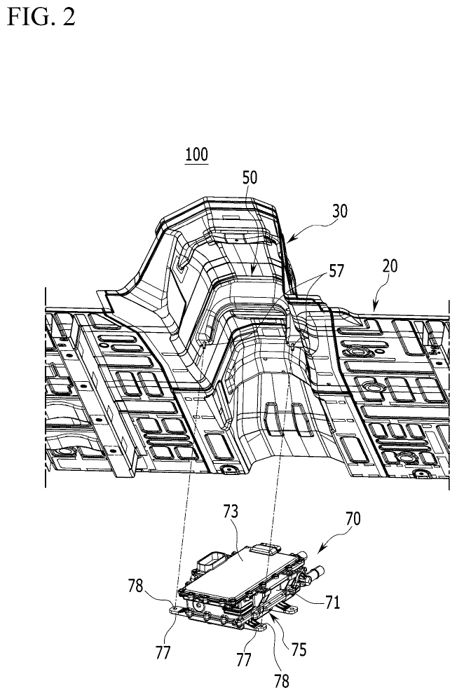

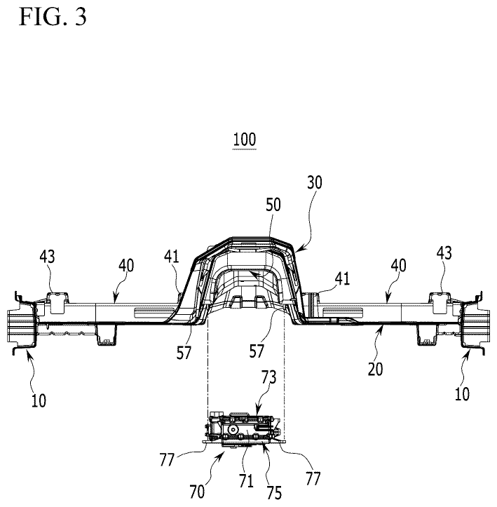

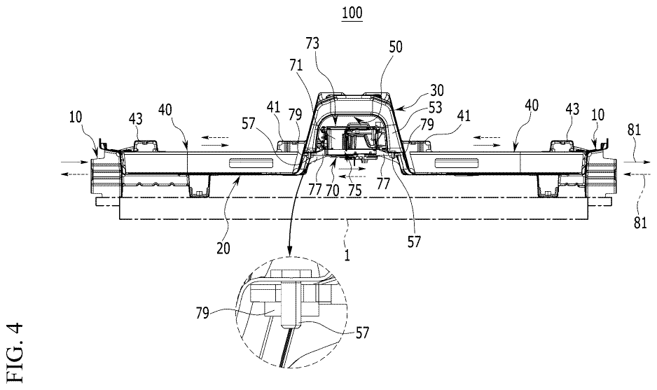

FIG. 1 is a perspective view illustrating a floor structure for an electric vehicle according to the disclosed embodiment, and FIG. 2 is a partially exploded perspective view illustrating a floor structure for an electric vehicle according to the disclosed embodiment. FIG. 3 is a partially exploded front view illustrating a floor structure for an electric vehicle according to the disclosed embodiment, and FIG. 4 is a cross-sectional view illustrating a floor structure for an electric vehicle

Referring to FIG. 1 to FIG. 4, a floor structure 100 for an electric vehicle according to the disclosed embodiment can be applied to a vehicle body of an electric vehicle. The floor structure 100 for an electric vehicle according to the disclosed embodiment can be applied to a center floor structure in a lower vehicle body structure of an electric vehicle.

At least one seat (not shown) may be mounted on the upper portion of the floor structure 100 for an electric vehicle according to the disclosed embodiment. A battery assembly 1 (e.g., as shown in FIG. 4) can be mounted on the lower portion of the floor structure 100 for an electric vehicle according to the disclosed embodiment.

In this specification, the ‘forward-backward direction of the vehicle body’ can be defined as the length direction or longitudinal direction of the vehicle body, the ‘vehicle width direction’ can be defined as the left-right direction or lateral direction of the vehicle body, and the ‘vertical direction’ can be defined as the height direction of the vehicle body.

In this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The floor structure 100 for an electric vehicle according to the disclosed embodiment provides a structure that can reinforce the bonding strength of a vehicle body and improve lateral collision performance.

The floor structure 100 for an electric vehicle according to the disclosed embodiment may include side sills 10, a center floor panel 20, seat cross members 40, at least one brace reinforcement member 50, and an inverter assembly 70.

In the disclosed embodiment, the side sills 10 are provided on each side of the floor structure 100 for an electric vehicle according to the disclosed embodiment along the vehicle width direction, and can be arranged along the forward-backward direction of the vehicle body.

In the disclosed embodiment, the center floor panel 20 can be connected to the side sills 10 and a tunnel member 30 arranged along the forward-backward direction of the vehicle body between the side sills 10.

The battery assembly 1 can be mounted on the lower portion of the center floor panel 20. The battery assembly 1 can be connected to the lower portion of the center floor panel 20 and side sills 10 by a fastening member, for example bolts and nuts.

In the disclosed embodiment, the tunnel member 30 is configured to mount electrical components connected to the battery assembly 1. The tunnel member 30 may, in one example, be provided with a ‘U’ cross-section shape. The lower sides of the tunnel member 30 can be connected to the center floor panel 20.

In the disclosed embodiment, the seat cross members 40 are configured to mount at least one seat (not shown).

The seat cross members 40 can be connected along the vehicle width direction to the upper portion of the center floor panel 20 with the tunnel member 30 in between. The seat cross members 40 can be connected to the side sills 10 and to the tunnel member 30 on both sides along the vehicle width direction.

As shown in FIG. 1, the seat cross members 40 may be provided in pairs along the vehicle width direction at the front of the center floor panel 20. The seat cross members 40 may be provided in pairs along the vehicle width direction at the rear of the center floor panel 20.

However, in the disclosed embodiment, seat cross members 40 arranged along the vehicle width direction at the front of the center floor panel 20 are described as an example.

The seat cross members 40 can be connected to both sides of the tunnel member 30 and the side sills 10 by an inner seat mounting bracket 41 and an outer seat mounting bracket 43.

The inner seat mounting bracket 41 can be connected by welding to one end of the seat cross members 40 and both sides of the tunnel member 30. The outer seat mounting bracket 43 can be connected by welding to the other end of the seat cross Members 40 and the Side Sills 10.

The seat cross members 40 are disconnected along the vehicle width direction by the tunnel member 30 and can be connected to both sides of the tunnel member 30 and the side sills 10 by the inner seat mounting bracket 41 and the outer seat mounting bracket 43.

The seat cross members 40 connect the side sills 10 and the tunnel member 30 along the vehicle width direction, and can absorb and support the load input through the side sills 10 in the event of a side collision of the vehicle.

In the disclosed embodiment, the at least one brace reinforcement member 50 forms a cross-section within the tunnel member 30 and is configured to reinforce the strength of the tunnel member 30. The at least one brace reinforcement member 50 can prevent deformation of the tunnel member 30 due to collision load in the event of a side collision of the vehicle.

The at least one brace reinforcement member 50 can be connected to the inside of the tunnel member 30 at a position corresponding to the seat cross members 40.

As shown in FIG. 2, the at least one brace reinforcement member 50 can be placed on the front portion of the tunnel member 30 at a position corresponding to the seat cross members 40 placed on the front portion of the center floor panel 20. The at least one brace reinforcement member 50 may be placed on the rear portion of the tunnel member 30 at a position corresponding to the seat cross members 40 placed on the rear portion of the center floor panel 20.

In the disclosed embodiment, the brace reinforcement member 50 placed on the front portion of the tunnel member 30 is described as an example.

At least one brace reinforcement member 50 may be placed inside the tunnel member 30 and between the seat cross members 40. For example, the at least one brace reinforcement member 50 may be provided in the shape of a ‘U’, which corresponds to the cross-section shape of the tunnel member 30.

The at least one brace reinforcement member 50 may be connected by welding to the inner surface of the tunnel member 30.

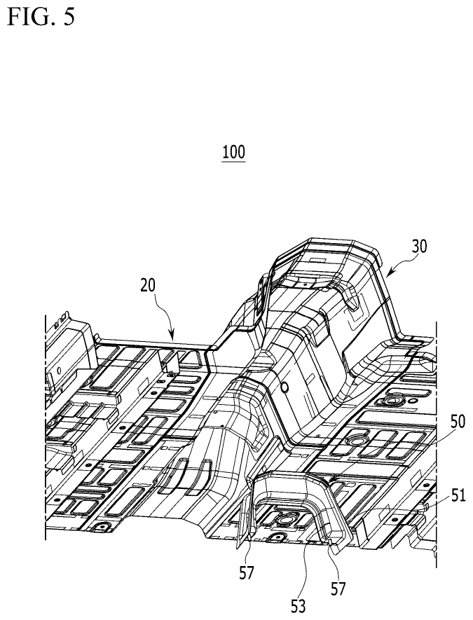

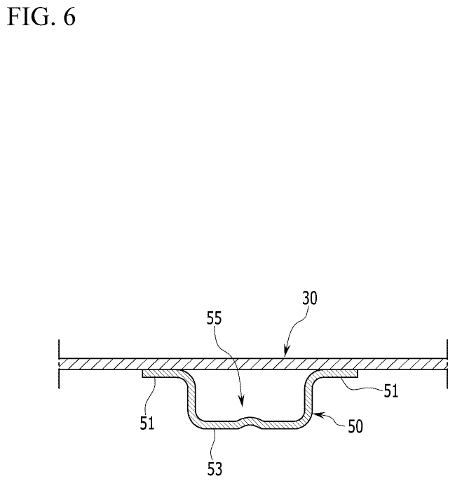

FIG. 5 is an exploded perspective view illustrating a brace reinforcement member applied to a floor structure for an electric vehicle according to the disclosed embodiment, and FIG. 6 is a cross-sectional view illustrating a brace reinforcement member applied to a floor structure for an electric vehicle according to the disclosed embodiment.

The at least one brace reinforcement member 50 may include a connecting flange portion 51 formed at the edge, as shown in FIG. 5. The connecting flange portion 51 can be connected to the inner surface of the tunnel member 30 by welding.

The at least one brace reinforcement member 50 may include a channel portion 53 formed in the inner region of the connecting flange portion 51. For example, the channel portion 53 may be provided with a cross-section shape of ‘∪’ extending from the connecting flange portion 51.

At least one brace reinforcement member 50 may include a closed cross-section 55 formed by the channel portion 53, as shown in FIG. 6, as connected to the inner surface of the tunnel member 30 via the connecting flange portion 51.

The at least one brace reinforcement member 50 may further include fasteners 57 provided on the lower sides of both sides. The fasteners 57 may include, for example, weld bolts secured to the lower portion of the channel portion 53.

Referring to FIG. 2 to FIG. 4, in the disclosed embodiment, the inverter assembly 70 is configured to convert DC power from battery assembly 1 into AC power. The inverter assembly 70 can be electrically connected to the battery assembly 1.

The inverter assembly 70 is positioned inside the tunnel member 30 and can be connected to at least one brace reinforcement member 50.

The inverter assembly 70 may include an inverter main body 71, an upper cover 73 connected to an upper portion of the inverter main body 71, and a lower cover 75 connected to a lower portion of the inverter main body 71.

The inverter main body 71 may include an electric power conversion device that converts DC power into AC power. The configuration and function of the inverter main body 71 are obvious to those skilled in the art, so a detailed description is omitted.

The upper cover 73 can be connected to the upper portion of at least one brace reinforcement member 50. The lower cover 75 may be connected to the lower portion of at least one brace reinforcement member 50.

The lower cover 75 can be connected to the lower portion of at least one brace reinforcement member 50 via the fasteners 57.

The lower cover 75 may include cantilever-shaped mounting ribs 77 that can be connected with the fasteners 57.

The mounting ribs 77 extend along the vehicle width direction on both sides of the lower cover 75 and can be arranged on the same line along the vehicle width direction as the seat cross members 40. The mounting ribs 77 can be connected along the vertical direction with the fasteners 57 of at least one brace reinforcement member 50.

Each of the mounting ribs 77 is formed with a fastening hole 78, into which the fasteners 57 can be inserted in the vertical direction as shown in FIG. 2. The fasteners 57 inserted in the vertical direction into the fastening holes 78 can be connected with nuts 79 as shown in see FIG. 4.

The lower cover 75 of the inverter assembly 70 can be connected to the lower portion of at least one brace reinforcement member 50 by the fasteners 57 and nuts 79.

The seat cross members 40, which are disconnected along the vehicle width direction by the tunnel member 30, can be connected to each other through at least one brace reinforcement member 50 and the mounting ribs 77 of the lower cover 75.

The mounting ribs 77 can form a load path 81 connected to the seat cross members 40 via the tunnel member 30 and the at least one brace reinforcement member 50.

Hereinafter, the operation of the floor structure 100 for an electric vehicle according to the disclosed embodiment configured as described above will be described in detail referring to FIG. 1 to FIG. 6.

In the disclosed embodiment, the center floor panel 20 is connected to the lower sides of the tunnel member 30 and the side sills 10 on both sides with the tunnel member 30 in between.

The seat cross members 40 are connected along the vehicle width direction to the upper portion of the center floor panel 20 with the tunnel member 30 in between.

The seat cross members 40 are connected to both sides of the tunnel member 30 and the side sills 10 by the inner seat mounting bracket 41 and the outer seat mounting bracket 43.

At least one brace reinforcement member 50 is connected to the inner surface of the tunnel member 30 via the connecting flange portion 51. The fasteners 57 are fixed to the lower sides of the channel portion 53 on at least one brace reinforcement member 50.

The inverter assembly 70 is connected to at least one brace reinforcement member 50. The battery assembly 1 is mounted on the lower portion of the center floor panel 20.

The inverter assembly 70 is connected to the fasteners 57 of at least one brace reinforcement member 50 via the mounting ribs 77 of the lower cover 75. The mounting ribs 77 are arranged in the same line as the seat cross members 40 along the vehicle width direction.

According to the floor structure 100 for an electric vehicle according to the disclosed embodiment, the seat cross members 40, the tunnel member 30, the at least one brace reinforcement member 50, and the inverter assembly 70 can be connected to each other along the vehicle width direction.

The seat cross members 40 that are disconnected along the vehicle width direction by the tunnel member 30 can be connected to each other through the tunnel member 30, the at least one brace reinforcement member 50, and the inverter assembly 70.

The floor structure 100 for an electric vehicle according to the disclosed embodiment can secure connectivity of components arranged along the vehicle width direction between the side sills 10, thereby reinforcing the connecting strength of the vehicle body.

The floor structure 100 for an electric vehicle according to the disclosed embodiment can secure robust connecting strength and mounting strength of at least one seat and the battery assembly 1. The floor structure 100 for an electric vehicle according to the disclosed embodiment can strengthen the bending rigidity of the vehicle body and improve the ride comfort of the vehicle.

The floor structure 100 for an electric vehicle according to the disclosed embodiment can form the load path 81 (e.g., as shown in FIG. 4) passing through the side sills 10, the seat cross members 40, the tunnel member 30, at least one brace reinforcement member 50, and the inverter assembly 70 along the vehicle width direction.

The floor structure 100 for an electric vehicle according to the disclosed embodiment can transfer a collision load input through one side sill 10 to the other side sill 10 through the load path 81 when the vehicle collides sideways. The floor structure 100 for an electric vehicle according to the disclosed embodiment can absorb and disperse collision loads through the seat cross members 40, the tunnel members 30, the at least one brace reinforcement member 50, and the inverter assembly 70.

The floor structure 100 for an electric vehicle according to the disclosed embodiment can minimize rotation of side sills 10 and minimize deformation of the vehicle body when the vehicle is in a side collision, thereby reducing the risk of injury to passengers.

The floor structure 100 for an electric vehicle according to the disclosed embodiment can secure the connecting strength of the battery assembly 1 and minimize damage to the battery assembly 1 due to a side collision of the vehicle.

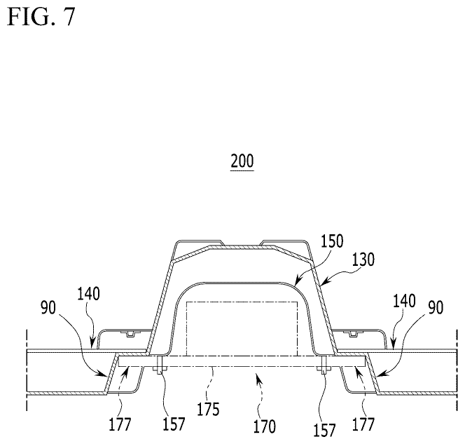

FIG. 7 is a cross-sectional view illustrating a floor structure for an electric vehicle according to another disclosed embodiment.

Referring to FIG. 7, a floor structure 200 for an electric vehicle according to another disclosed embodiment may be based on the structure of the previously disclosed embodiment, and may further include forming portions 90 formed on both sides of a tunnel member 130.

In the disclosed embodiment, the forming portion 90 is formed to protrude outwardly on both sides of the tunnel member 130. In the disclosed embodiment, forming means a forming method in which both sides of the tunnel member 130 are plastically deformed by a press method or the like, thereby convexly expanding some cross-sections of the both sides outward.

The forming portion 90 can be formed at a position corresponding to the lower portion of both sides of at least one brace reinforcement member 150 on both sides of the tunnel member 130, i.e., at a position corresponding to seat cross members 140. The forming portion 90 can be disposed inside the seat cross members 140.

In the disclosed embodiment, a lower cover 175 of an inverter assembly 170 may include cantilever-shaped mounting ribs 177 extending from the inner side of the tunnel member 130 to the forming portion 90.

The mounting ribs 177 can support the forming portion 90 on the inner side of the tunnel member 130. The mounting ribs 177 can be connected to fasteners 157 provided on at least one brace reinforcement member 150.

The cross-sections of the seat cross members 140 and the mounting ribs 177 can overlap by the forming portion 90.

According to another embodiment disclosed, the floor structure 200 for an electric vehicle can provide a structure in which the shape of the tunnel member 130 and the shape of the inverter assembly 170 are changed.

According to another embodiment of the disclosed floor structure 200 for an electric vehicle, the cross-sections of the seat cross members 140 and the mounting ribs 177 overlap by the forming portion 90, thereby further improving the side collision performance of the vehicle.

According to another embodiment of the floor structure 200 for an electric vehicle disclosed herein, side collision performance can be satisfied by only changing the shape of the tunnel member 130 and the inverter assembly 170 without adding a separate reinforcing structure to the tunnel member 130, thereby minimizing the weight increase of the vehicle body.

The other configurations and operations of the floor structure 200 for an electric vehicle according to another disclosed embodiment are the same as in the previously described embodiment, so a detailed description thereof will be omitted.

Although the disclosed embodiments have been described above, the technical idea is not limited to the disclosed embodiments presented in this specification, and a person skilled in the art who understands the technical idea will be able to easily propose other disclosed embodiments by adding, changing, deleting, or adding components within the scope of the same technical idea, but this will also be considered to fall within the scope of the rights of the present invention.

What is claimed is:

1. A floor structure for an electric vehicle, the floor structure comprising:
a center floor panel connected to a first side sill, a second side sill, and a tunnel member disposed along a forward-backward direction of a vehicle body;
a first seat cross member connected along a vehicle width direction to a center floor panel upper portion of the center floor panel and connected to a first tunnel member side of the tunnel member and to the first side sill;
a second seat cross member connected along the vehicle width direction to the center floor panel upper portion and connected to a second tunnel member side of the tunnel member and to the second side sill;
a brace reinforcement member connected to an inside of the tunnel member in a first position corresponding to the first seat cross member and the second seat cross member; and
an inverter assembly connected with the brace reinforcement member.

2. The floor structure of claim 1, further comprising:
a first inner seat mounting bracket connected to a first inner end of the first seat cross member and to the tunnel member;
a second inner seat mounting bracket connected to a second inner end of the second seat cross member and to the tunnel member;
a first outer seat mounting bracket connected to a first outer end of the first seat cross member and to the first side sill; and
a second outer seat mounting bracket connected to a second outer end of the second seat cross member and to the second side sill.

3. The floor structure of claim 1, wherein the brace reinforcement member is disposed between the first seat cross member and the second seat cross member within the tunnel member and connected to an inner surface of the tunnel member with a U-shape.

4. The floor structure of claim 3, wherein the brace reinforcement member is connected to the inner surface of the tunnel member through a connecting flange portion formed at an edge.

5. The floor structure of claim 1, wherein the inverter assembly comprises:
an inverter main body;
an upper cover connected to an inverter main body upper portion of the inverter main body; and
a lower cover connected to an inverter main body lower portion of the inverter main body and connected to the brace reinforcement member.

6. The floor structure of claim 5, wherein the brace reinforcement member is connected to the lower cover through a first fastener provided on a first lower side and through a second fastener provided on a second lower side.

7. The floor structure of claim 6, wherein the lower cover comprises:
a first cantilever-shaped mounting rib connected with the first fastener; and
a second cantilever-shaped mounting rib connected with the second fastener.

8. The floor structure of claim 7, wherein the first cantilever-shaped mounting rib and the second cantilever-shaped mounting rib are disposed in a same line as the first seat cross member and the second seat cross member along the vehicle width direction.

9. The floor structure of claim 7, wherein the first seat cross member and the second seat cross member, which are disconnected along the vehicle width direction by the tunnel member, are connected through the brace reinforcement member, the first cantilever-shaped mounting rib, and the second cantilever-shaped mounting rib.

10. The floor structure of claim 7, wherein the first cantilever-shaped mounting rib and the second cantilever-shaped mounting rib form a load path that is connected to the first seat cross member and the second seat cross member through the tunnel member and the brace reinforcement member.

11. The floor structure of claim 1, wherein the tunnel member comprises:
a forming portion that protrudes outward at a second position corresponding to lower sides of the brace reinforcement member and is disposed on a first inner side of the first seat cross member and a second inner side of the second seat cross member.

12. The floor structure of claim 11, wherein the inverter assembly comprises:
an inverter main body; and
a lower cover connected to:
an inverter main body lower portion of the inverter main body;
a first brace reinforcement member lower portion of a first brace reinforcement side of the brace reinforcement member; and
a second brace reinforcement member lower portion of a second brace reinforcement member side of the brace reinforcement member.

13. The floor structure of claim 12, wherein the lower cover comprises:
a first mounting rib extending from a tunnel member inner side of the tunnel member to the forming portion and connected to a first fastener provided on the brace reinforcement member; and
a second mounting rib extending from the tunnel member inner side to the forming portion and connected to a second fastener provided on the brace reinforcement member.

14. The floor structure of claim 13, wherein a first cross-section of the first seat cross member and the second seat cross member, and a second cross-section of the first mounting rib and the second mounting rib, overlap by the forming portion.

15. The floor structure of claim 1, wherein a battery assembly is mounted on a lower portion of the center floor panel.

16. A floor structure for an electric vehicle, the floor structure comprising:
a center floor panel;
a first side sill connected to a first center floor panel side of the center floor panel in a forward-backward direction of a vehicle body;
a second side sill connected to a second center floor panel side of the center floor panel in the forward-backward direction;
a tunnel member connected to the center floor panel between the first side sill and the second side sill in the forward-backward direction;
a first seat cross member connected to:
an upper portion of the center floor panel along a vehicle width direction of the vehicle body
the first side sill by a first outer seat mounting bracket; and
a first tunnel member side of the tunnel member by a first inner seat mounting bracket;
a second seat cross member connected to:
the upper portion of the center floor panel along the vehicle width direction;
the second side sill by a second outer seat mounting bracket; and
a second tunnel member side of the tunnel member by a second inner seat mounting bracket;
a brace reinforcement member connected to an inside of the tunnel member in a position corresponding to the first seat cross member and the second seat cross member; and
an inverter assembly connected to the brace reinforcement member.

17. The floor structure of claim 16, wherein:
the brace reinforcement member is disposed within the tunnel member between the first seat cross member and the second seat cross member, and
the brace reinforcement member is connected to the inside of the tunnel member with a U-shape.

18. A floor structure for an electric vehicle, the floor structure comprising:
a center floor panel;
a first side sill connected to a first center floor panel side of the center floor panel in a forward-backward direction of a vehicle body;
a second side sill connected to a second center floor panel side of the center floor panel in the forward-backward direction;
a tunnel member connected to the center floor panel between the first side sill and the second side sill in the forward-backward direction;
a first seat cross member connected to a center floor panel upper portion of the center floor panel along a vehicle width direction of the vehicle body, the first side sill, and a first tunnel member side of the tunnel member;
a second seat cross member connected to the center floor panel upper portion along the vehicle width direction, the second side sill, and a second tunnel member side of the tunnel member;
a brace reinforcement member connected to an inside of the tunnel member in a position corresponding to the first seat cross member and the second seat cross member; and
an inverter assembly connected to the brace reinforcement member
wherein the inverter assembly comprises:
an inverter main body;
an upper cover connected to an inverter main body upper portion of the inverter main body; and
a lower cover connected to an inverter main body lower portion of the inverter main body and connected to the brace reinforcement member.

19. The floor structure of claim 18, wherein the brace reinforcement member is connected to the lower cover through a first fastener on a first lower side and through a second fastener on a second lower side.

20. The floor structure of claim 19, wherein the lower cover comprises:
a first cantilever-shaped mounting rib connected with the first fastener; and
a second cantilever-shaped mounting rib connected with the second fastener.
